(19) United States
(12) Patent Application Publication
(10) Pub. No.: US 2020/0215883 A1
(43) Pub. Date: Jul. 9, 2020

(54) OPERATOR FOR VEHICLE SIDE DOOR

(71) Applicant: MITSUI KINZOKU ACT CORPORATION, Kanagawa (JP)

(72) Inventors: Kiichi Noguchi, Kanagawa (JP); Shungo Ikeno, Kanagawa (JP); Shintaro Okawa, Kanagawa (JP); Kazuyuki Sasaki, Kanagawa (JP)

(21) Appl. No.: 16/709,742

(22) Filed: Dec. 10, 2019

(30) Foreign Application Priority Data
Jan. 8, 2019 (JP) 2019-001487

(51) Int. Cl. B60J 5/04; F16H 19/00; E05F 15/614

(52) U.S. Cl. CPC B60J 5/0472; F16H 2019/046; E05F 15/614; F16H 19/001

(57) ABSTRACT

An operator for a vehicle side door includes: a drive unit; a pinion gear fixed to an output shaft of the drive unit; a rack including a rack gear, the rack gear being configured to engage with the pinion gear; a connecting arm pivotally supported on a vehicle body side bracket fixed to the vehicle body, the connecting arm being connected to a front end of the rack; and a contact stopper fixed to a rear end of the rack, wherein the side door moves in a direction of opening the door when the rack moves forward by the rotation of the pinion gear and the side door moves in a direction of closing the door when the rack moves backward by rotation of the pinion gear, and the contact stopper is configured to come into contact with the drive unit when the rack moves forward by a specified amount.

The present application claims priority to and incorporates by reference the entire contents of Japanese Patent Application No. 2019-001487 filed in Japan on Jan. 8, 2019.

### BACKGROUND

The present disclosure relates to an operator for a vehicle side door.

In common operators for vehicle side doors, when a door latch device is unlatched, a drive unit causes a side door to move to a position at which the door is fully opened so as to open the door, and, when a door closing switch is operated in a state in which the door is open, the drive unit is activated to close the door, thereby moving the side door so as to close the door. A side door including an operator is sometimes referred to as a “power hinge door”. There are various settings as to conditions and timing for a drive unit of an operator to start up so as to open a door, as well as conditions and timing for moving the door so as to close the door.

Japanese Patent Application Laid-open No. 2017-128940 and Japanese Laid-open Patent Publication (Translation of PCT Application) No. 2018-505326 both disclose a structure in which a drive unit of an operator is attached to an inner space of a side door. The drive unit attached to the inside of the side door is connected through a connecting mechanism to a bracket of a vehicle body, and power of the drive unit causes the connecting mechanism to expand and contract, thereby moving the side door with respect to the vehicle body so as to open and close the door.

The drive unit and the connecting mechanism described above included no mechanism suitable for mechanically stopping the side door at a position at which the door is fully opened.

### SUMMARY

In some embodiments, in an operator for a vehicle side door rotatably attached to a vehicle body by a pair of upper and lower door hinges, the operator includes: a drive unit attached to the side door; a pinion gear fixed to an output shaft of the drive unit; a rack including a rack gear, the rack gear being configured to engage with the pinion gear; a connecting arm pivotally supported on a vehicle body side bracket fixed to the vehicle body, the connecting arm being connected to a front end of the rack; and a contact stopper fixed to a rear end of the rack, wherein the side door moves in a direction of opening the door when the rack moves forward by the rotation of the pinion gear and the side door moves in a direction of closing the door when the rack moves backward by rotation of the pinion gear, and the contact stopper is configured to come into contact with the drive unit so as to prevent the rack from moving forward when the rack moves forward by a specified amount.

The above and other objects, features, advantages and technical and industrial significance of this disclosure will be better understood by reading the following detailed description of presently preferred embodiments of the disclosure, when considered in connection with the accompanying drawings.

### BRIEF DESCRIPTION OF THE DRAWINGS

FIG. 1 is a schematic side view of a vehicle having a side door provided with an operator according to an embodiment;

FIG. 2 is a schematic vertical sectional view of a side door illustrating an attachment position of a drive unit of the operator;

FIG. 3 is a perspective view illustrating the internal components of the side door with an inside panel removed therefrom;

FIG. 4 is a front view of the drive unit of the operator when viewed from the outdoor side;

FIG. 5 is an overall perspective view of the drive unit of the operator;

FIG. 6 is a perspective view schematically illustrating the internal components of the drive unit;

FIG. 7 is a plan view of a vehicle body side bracket, a pinion gear of the drive unit, and a rack in a state in which the door is closed;

FIG. 8 is a plan view of the rack of FIG. 7 in a state in which the rack is moved so as to open the door;

FIG. 9 is a perspective view of an engagement holding unit that holds the engagement of a rack gear and the pinion gear;

FIG. 10 is an exploded perspective view of the engagement holding unit;

FIG. 11 is a vertical sectional view of the engagement holding unit;

FIG. 12 is an exploded perspective view of the rack; and

FIG. 13 is a block circuit diagram.

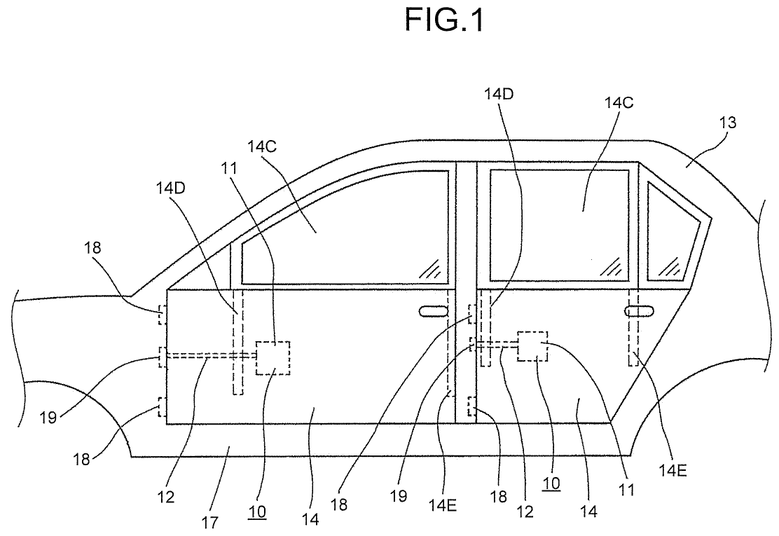

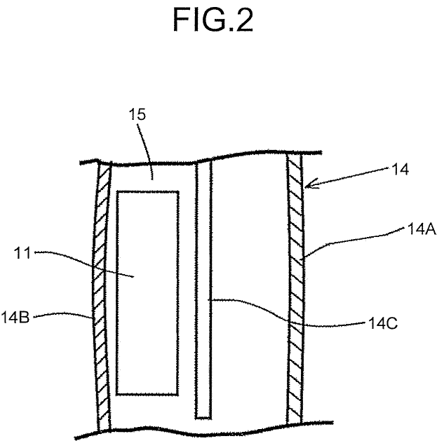

### DETAILED DESCRIPTION

Exemplary embodiments are described with reference to the accompanying drawings. An operator 10 for a vehicle side door according to the present disclosure includes a drive unit 11 and a connecting mechanism 12. The drive unit 11 is arranged in a storage space 15 inside a side door 14 of a vehicle 13.

The side door 14 includes a metallic outer panel 14A and a metallic inner panel 14B, and the metallic inner panel 14B has preferably a trim panel (not illustrated) attached thereto. The side door 14 includes a door glass 14C that is lifted and lowered by a lifting and lowering mechanism 16. The front edge and the rear edge of the door glass 14C are slidably sandwiched by a front guide rail 14D and a rear guide rail 14E, and the door glass 14C is lifted and lowered between the metallic outer panel 14A and the metallic inner panel 14B.

When lowered, the door glass 14C divides a space between the metallic outer panel 14A and the metallic inner panel 14B into substantially halves. The storage space 15 is a space partitioned by the door glass 14C (including an extended line of a downward movement locus of the door glass 14C) and the metallic inner panel 14B.

The side door 14 is rotatably attached to a vehicle body 17 by a pair of upper and lower door hinges 18. To the vehicle body 17, a vehicle body side bracket 19 is fixed. The vehicle body side bracket 19 is arranged between the upper and lower door hinges 18. The vehicle body side bracket 19 is connected through the connecting mechanism 12 to the drive unit 11. When power from the drive unit 11 is transmitted to the vehicle body side bracket 19, the side door 14 is rotated about the door hinges 18 in a direction of opening the door or in a direction of closing the door. At this time, because the vehicle body side bracket 19 is arranged midway between the upper and lower door hinges 18, the power from the drive unit 11 is transmitted to the vehicle body 17 efficiently and smoothly.

The drive unit 11 has a motor 20 arranged at the top thereof and a pinion gear 21 serving as an output gear arranged at the bottom thereof. Output from the motor 20 is transmitted to a first deceleration part 22 located therebelow. For the first deceleration part 22, a planetary gear mechanism is preferably used.

Output from the first deceleration part 22 is transmitted through a brake part 23 located therebelow to a second deceleration part 24. The brake part 23 has a brake assembly 23A and an armature 23B. The brake part 23 is preferably a spring actuated type electromagnetic brake, and a permanent magnet is used for braking. In the brake part 23, the armature 23B is normally attracted by the permanent magnet, whereby the brake is in an actuated state, and a predetermined braking resistance can be given to the side door 14. The braking resistance of the brake part 23 is released by applying voltage to the brake assembly 23A, and the brake is freed. The pinion gear 21 is fixed to an output shaft 24A of the second deceleration part 24. For the second deceleration part 24, a planetary gear mechanism is preferably used.

The drive unit 11 takes on a linear shape extending vertically, and has the motor 20, the first deceleration part 22, the brake part 23, and the second deceleration part 24 aligned vertically, thereby minimizing a displacement in a lateral direction (horizontal direction). This structure allows the drive unit 11 to be an elongated cylindrical drive unit extending vertically, and facilitates storage of the drive unit 11 in the storage space 15 having a small width.

More preferably, the drive unit 11 has a driveline from a motor shaft 20A of the motor 20 through to the output shaft 24A, to which the pinion gear 21 is fixed, arranged in a line centered on the motor shaft 20A. For example, when a planetary gear mechanism is used for the deceleration parts, a shaft of a sun gear is aligned with a shaft core of the motor shaft 20A. This structure enables the drive unit 11 to have a further reduced size in a radial direction of the motor shaft 20A.

An upper bracket 25 of the drive unit 11 is fixed to the metallic inner panel 14B with a fastener 26.

A rack gear 27A formed on a rack 27 of the connecting mechanism 12 is engaged with the pinion gear 21. The rack 27 extends horizontally in a fore-and-aft direction of the door, a front end of the rack 27 passes through an opening (not illustrated) of a door front panel (not illustrated) to protrude forward, and the front end is pivotally supported on a rotating end of a connecting arm 29 by a connecting shaft 28. A base end of the connecting arm 29 is pivotally supported on the vehicle body side bracket 19 by a bracket shaft 19A. The opening of the door front panel is shielded by a cosmetic cover 30, for example.

A part in which the pinion gear 21 and the rack gear 27A are engaged with one another is held inside an engagement holding unit 31. The engagement holding unit 31 prevents a gap in a pitch between the pinion gear 21 and the rack gear 27A and a displacement of the engagement position of the pinion gear 21 and the rack gear 27A in a shaft center direction of the output shaft 24A.

The engagement holding unit 31 includes a substantially L-shaped upper cover 32 and a rectangular flat-shaped lower base 33. A horizontal part 32A of the upper cover 32 is fixed to the lower part of the drive unit 11 (the second deceleration part 24). A bent part 32B of the upper cover 32 is arranged on the indoor side and is fixed to the metallic inner panel 14B with a fastener 34.

The horizontal part 32A and the lower base 33 are fixed with four vertical pillars 35, 35, 36, 36 at predetermined spacings. Two vertical pillars 35, 35 on the indoor side may be normal prisms, whereas two vertical pillars 36, 36 on the outdoor side have rotary rollers 36A, 36A pivotally mounted to the outer periphery thereof. The rotary rollers 36A, 36A have a non-gear face 27B of the rack 27 brought into contact therewith.

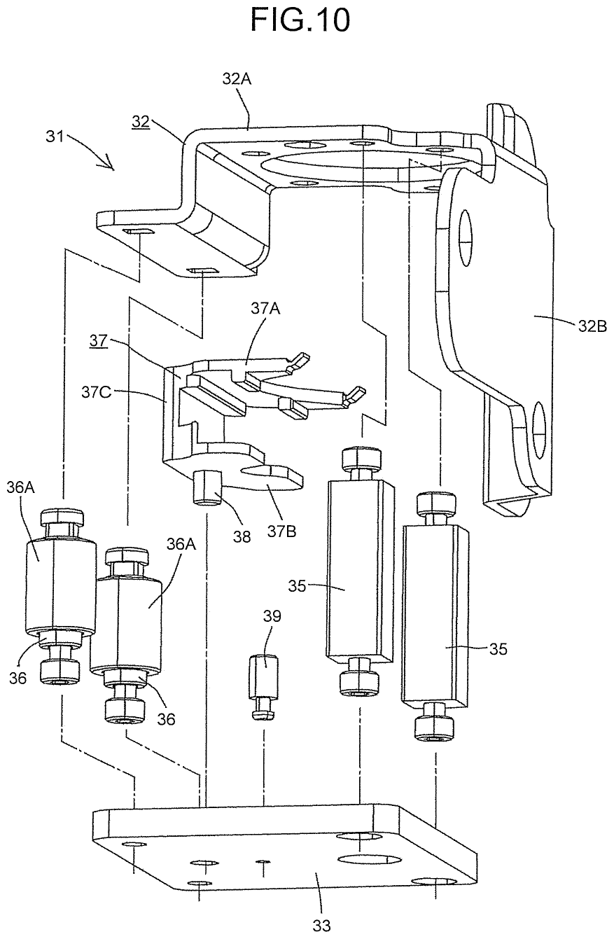

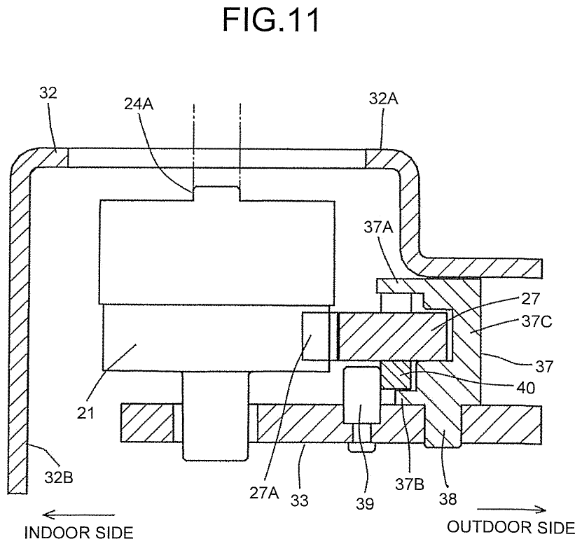

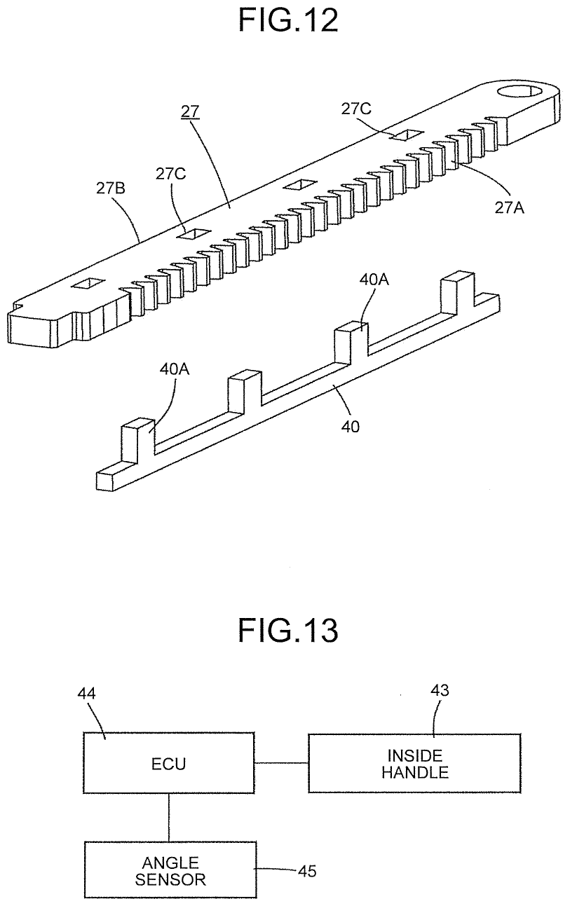

A rack guide body 37 is pivotally supported on the lower base 33 by a guide support shaft 38. The rack guide body 37 includes a top face 37A, a bottom face 37B, and a side face 37C that connects the outdoor side of the top face 37A and the bottom face 37B to one another. As illustrated in FIGS. 10 and 11, a hold-down pin 39 that stands upward is implanted in the lower base 33. The hold-down pin 39 is arranged on a line connecting the output shaft 24A and the guide support shaft 38.

The rack 27 is restricted from moving in an up-and-down direction by the top face 37A and the bottom face 37B of the rack guide body 37.

The rack 27 is moved forward (in the direction of opening the door) or backward (in the direction of closing the door) by rotation of the pinion gear 21. The rack 27 swings slightly about the connecting shaft 28 at the front end during the movement. The swing is absorbed because the rack guide body 37 swings about the guide support shaft 38, so that disengagement of the rack gear 27A and the pinion gear 21 is avoided.

A steel rack slider 40 is attached to the rack 27. Preferably, upper projections 40A of the rack slider 40 are inserted into through holes 27C of the rack 27, and then caulked to be fixed to the rack 27. The rack slider 40 extends like a rail on a bottom face of the rack 27 in a longitudinal direction of the rack 27.

The rotary rollers 36A, 36A come into contact with the non-gear face 27B of the rack 27 from the outdoor side, the hold-down pin 39 of the lower base 33 comes into contact with the rack slider 40 of the rack 27 from the indoor side, as illustrated in FIG. 11, which facilitates the smooth movement of the rack 27 in a fore-and-aft direction without generating a backlash.

A contact stopper 41 is fixed to a rear end of the rack 27. The contact stopper 41 is made up of a central steel member 41A and an elastic body 41B that surrounds the outer periphery of the steel member 41A. The steel member 41A is fitted into the rear end of the rack 27, and then is fixed by welding.

When the rack 27 is moved in the direction of opening the door (forward) and the side door 14 reaches a position at which the door is fully opened, the elastic body 41B of the contact stopper 41 comes into contact with the engagement holding unit 31, preferably with a structure, such as the upper cover 32 and the lower base 33. Thus, the position of the side door 14 at which the door is fully opened is defined by mechanical contact, and structural deformation is also prevented of the drive unit 11, the connecting mechanism 12, and the door hinges 18 resulting from the side door 14 moving beyond the position at which the door is fully opened.

A spring actuated type electromagnetic brake is employed for the brake part 23 of the drive unit 11, and the brake is actuated in a non-energized standby state. Braking force (holding torque) by the brake part 23 preferably generates two types of brakes: a strong brake during non-energization and a weak brake when energization is controlled. The strong brake is set to the same degree as a braking resistance (50 Nm) when the side door is temporarily held by a common check link. Thus, the strong brake of the brake part 23 can complement the function of a check link in the present embodiment, so that a check link can be omitted.

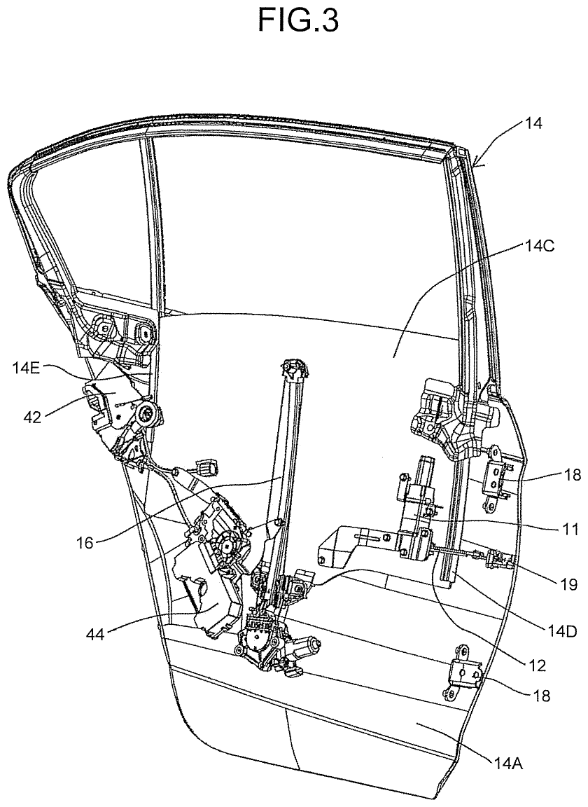

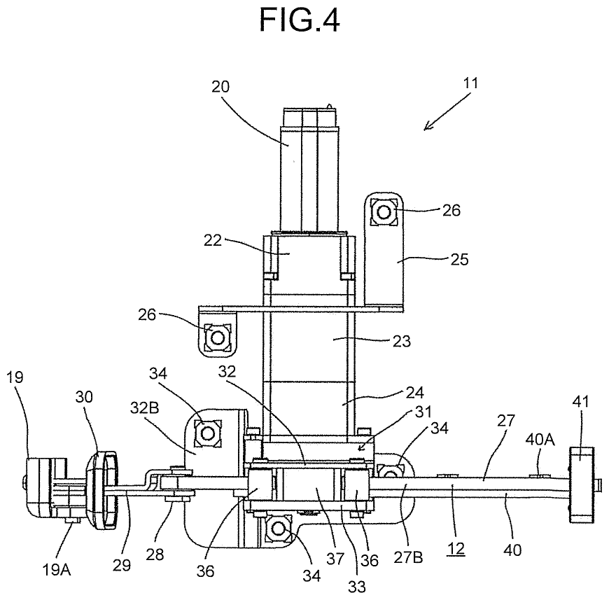

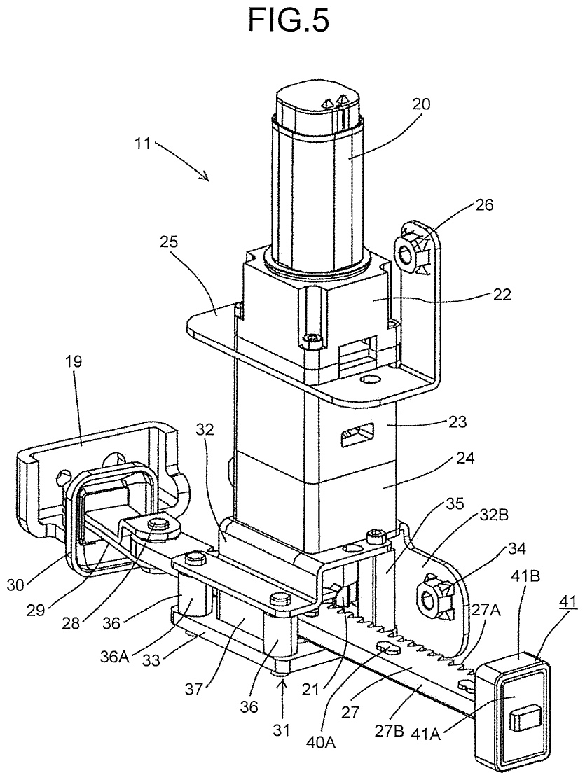

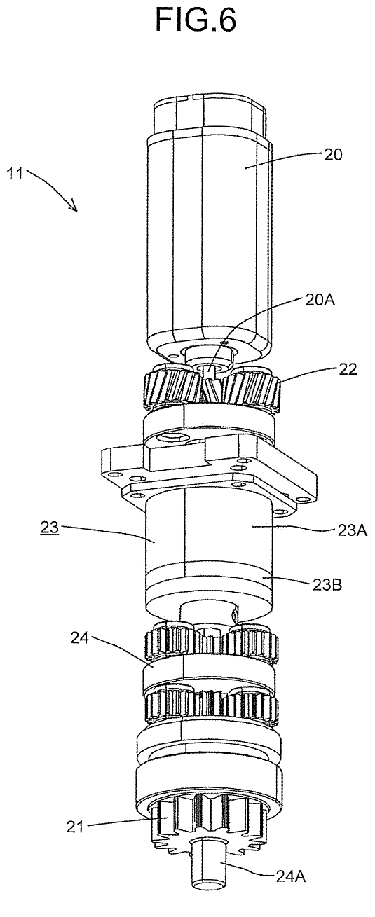

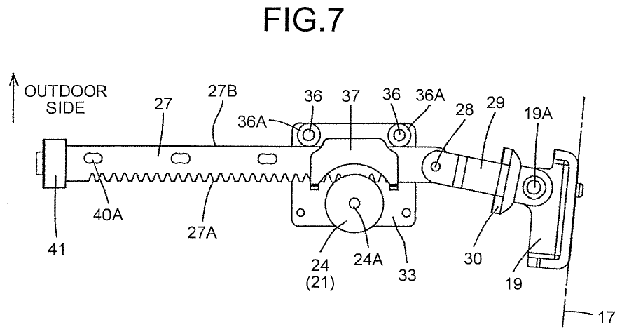

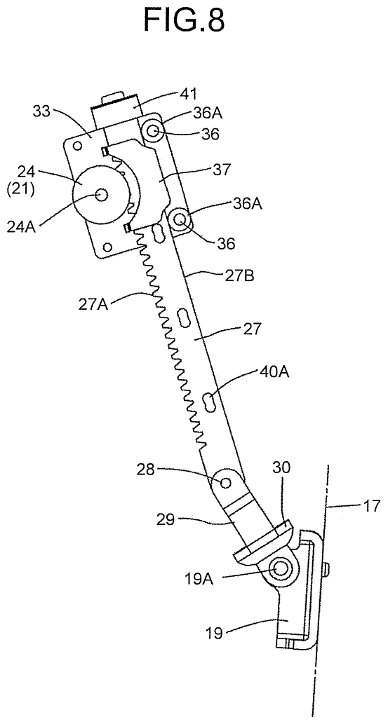

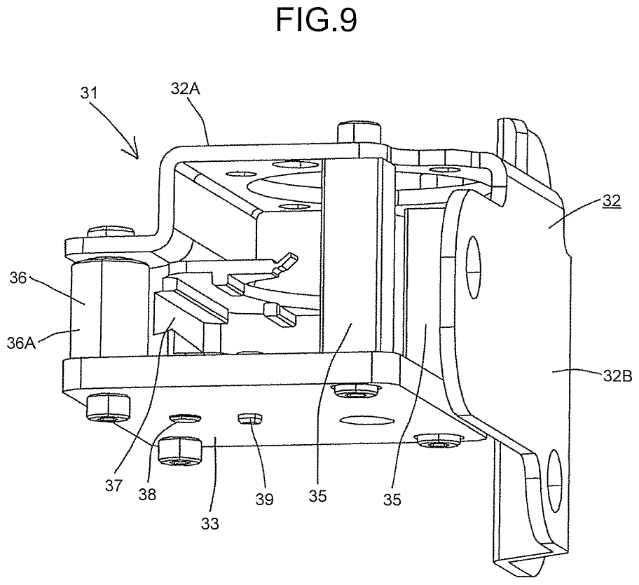

In a state in which the door is closed with a door latch device 42 (FIG. 3) engaged with a striker, the brake part 23, which is in a non-energized standby state, generates a strong brake. When a passenger unlatches the door latch device 42 by operation of an inside handle 43 from the inside of the vehicle in a state in which the door is closed, the brake part 23 is energized and the brake is turned off in conjunction with the foregoing operation, the side door 14 is pushed out by a seal reaction force or the like from a position at which the door is closed, and the passenger also pushes the side door 14 from the indoor in the direction of opening the door, thereby further moving the side door 14 in the direction of opening the door.

When the side door 14 is moved from the position at which the door is closed, in the direction of opening the door, the brake part 23 releases the brake, which sometimes causes the side door 14 to be opened suddenly and unexpectedly as a consequence of a tilt of the vehicle 13 to the front, rear, and sides, and strong winds, for example. As a countermeasure, when the side door 14 is moved to a predetermined position at which the door is temporarily opened, the brake part 23 generates a weak brake with control of energization, thereby preventing the side door 14 from being opened suddenly beyond the position at which the door is temporarily opened.

The position of the side door 14 at which the door is temporarily opened is preferably at an opening angle of the door of approximately ten degrees, and the angle corresponds to opening of the door equivalent to the thickness of the side door 14. The position of the side door 14 at which the door is temporarily opened is detected by an angle sensor 45 connected to an engine control unit (ECU) 44, for example.

When the side door 14 reaches the position at which the door is temporarily opened, the brake part 23 generates a weak brake for about one to two seconds. It is desirable that a holding force of the weak brake acting on the side door 14 is set to be moderate in such a manner that the passenger does not feel a sense of discomfort when pushing the side door 14 to the outside in a series of operations of opening the door.

Application of the weak brake to the side door 14 at the position at which the door is temporarily opened can be limited to when the passenger performs operations of opening the door using the inside handle 43 from the indoor. When performing operations of opening the door using an outside handle from the outdoor, an operating person is right outside the side door 14, which reduces the need to apply the weak brake to the side door 14. Also, when the side door 14 passes through the position at which the door is temporarily opened so as to close the door, the weak brake is not applied to the side door 14.

When the side door 14 is moved in the direction of opening the door beyond the position at which the door is temporarily opened, the brake part 23 applies a strong brake to the side door 14 at a predetermined position. Preferably, when the side door 14 is opened at approximately 25 degrees, the side door 14 is given a predetermined opening resistance of the door by the strong brake. This produces the same effect as a stepping resistance given to a side door by a common check link.

A strong brake is optionally applied to the side door 14 by bringing the brake part 23 into a non-energized state. Consequently, the brake part 23 is configured to, when the side door 14 has been maintained at the same angle for a predetermined time frame, maintain the side door 14 at the given opening angle of the door by generating a strong brake.

In the present disclosure, the position of the side door 14 at which the door is fully opened can be defined by bringing the contact stopper 41 fixed to the rack 27 into mechanical contact with the drive unit 11, so that adequate strength can be ensured without burdening the door hinges 18.

Moreover, in the present disclosure, the contact stopper 41 can be brought into contact with a structure of the drive unit 11, so that strength can be further ensured.

Moreover, in the present disclosure, the elastic body 41B of the contact stopper 41 can be brought into contact with the drive unit 11, so that quiet performance is improved.

Moreover, in the present disclosure, the contact stopper 41 is brought into contact with a structure of the engagement holding unit 31 that has improved strength, so that additional strength can be ensured.

Moreover, in the present disclosure, the drive unit 11 can be overlapped with the door glass 14C in a width direction of the door, so that the operator can also be appropriate for a rear side door.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An operator for a vehicle side door rotatably attached to a vehicle body by a pair of upper and lower door hinges, the operator comprising:
a drive unit attached to the side door;
a pinion gear fixed to an output shaft of the drive unit;
a rack including a rack gear, the rack gear being configured to engage with the pinion gear;
a connecting arm pivotally supported on a vehicle body side bracket fixed to the vehicle body, the connecting arm being connected to a front end of the rack; and
a contact stopper fixed to a rear end of the rack, wherein
the side door moves in a direction of opening the door when the rack moves forward by the rotation of the pinion gear and the side door moves in a direction of closing the door when the rack moves backward by rotation of the pinion gear, and
the contact stopper is configured to come into contact with the drive unit so as to prevent the rack from moving forward when the rack moves forward by a specified amount.

2. The operator for a vehicle side door according to claim 1, wherein the contact stopper is brought into contact with an upper cover configured to fix the drive unit to the side door.

3. The operator for a vehicle side door according to claim 1, wherein the contact stopper is brought into contact with the drive unit before the door hinges reach a rotation limit.

4. The operator for a vehicle side door according to claim 1, wherein the contact stopper includes:
a steel member fixed to the rack; and
an elastic body provided on an outer periphery of the steel member, the elastic body being configured to come into contact with the drive unit.

5. The operator for a vehicle side door according to claim 1, wherein the pinion gear and the rack gear are engaged with one another inside a frame body of an engagement holder that includes an upper cover and a lower base, and the contact stopper is brought into contact with the frame body.

6. The operator for a vehicle side door according to claim 1, wherein the side door includes a metallic outer panel, a metallic inner panel, and a door glass configured to be movable in a vertical direction, and the drive unit is arranged in a storage space formed between a downward movement locus line of the door glass and the metallic inner panel.
